(19) United States
(12) Patent Application Publication
(10) Pub. No.: US 2016/0162863 A1
(43) Pub. Date: Jun. 9, 2016

(54) SYSTEM, METHOD AND SOFTWARE FOR HOUSE AUTOMATION CONFIGURATION AT POINT OF SALE

(71) Applicant: Alba Smart AS, Haugesund (NO)

(72) Inventor: Arne LANDA, Haugesund (NO)

(21) Appl. No.: 15/042,531

(22) Filed: Feb. 12, 2016

Related U.S. Application Data
(63) Continuation of application No. 13/121,579, filed on Apr. 26, 2011, now abandoned.

(30) Foreign Application Priority Data
Sep. 29, 2008 (NO) NO20084122
Aug. 18, 2009 (NO) PCT/NO2009/000293

(51) Int. Cl. G06Q 20/20; H04L 12/28

(52) U.S. Cl. CPC G06Q 20/202; H04L 12/2807

(57) ABSTRACT

A Point of sale device, system and computer program for configuration of house automation, including a reader arranged to read an identity associated with a sensor for home automation, an interface arranged to receive input of installation data of the sensor; and a communication module arranged to send the installation data and associated identity of the sensor to a server.

### CROSS-REFERENCE TO RELATED APPLICATION

This application is a continuation of U.S. patent application Ser. No. 13/121,579, entitled “SYSTEM, METHOD AND SOFTWARE FOR HOUSE AUTOMATION CONFIGURATION AT POINT OF SALE”, having a National Phase Entry date of Apr. 26, 2011 for PCT Application Serial No.: PCT/NO2009/000293, filed Aug. 18, 2009, entitled SYSTEM, METHOD AND SOFTWARE FOR HOUSE AUTOMATION CONFIGURATION AT POINT OF SALE, which application claims priority to Norwegian Patent NO20084122, filed Sep. 29, 2008, the entire contents of each of which are hereby incorporated herein by reference.

### STATEMENT REGARDING FEDERALLY SPONSORED RESEARCH OR DEVELOPMENT

n/a

### FIELD OF THE INVENTION

The present invention relates to a method, system and software for house automation, in particular for configuration of such systems at the point of sale.

### BACKGROUND OF THE INVENTION

House automation is a wide area of automation techniques for the comfort and security of residents and workers in homes, public buildings and office buildings. Building automation can include functions for light and climate control, control of doors and window shutters, security and surveillance systems are used in home automation. Moreover, additional functions can include:
“telecare”, such as surveillance and caring functions for babies, children, elderly and disabled persons,
the control of multimedia information or entertainment,
pet feeding and
other more homely functions than those used in office.

House automation systems, including alarms and security sensors, e.g. for burglary, fire or water leakages, have traditionally been installed and configured by professionals.

A system consists of various sensors, e.g. smoke, movement, water, and various controls, communications, actuators and alarm units, that e.g. will sound an alarm signal, shut a valve, switch of electricity or contact the fire brigade or security using dedicated communication, such as satellite links or fixed lines, or publicly available communication means such as mobile phone systems or the Internet.

The sensors and units are interconnected using dedicated cabling or a dedicated wireless network, in order to avoid configuration problems on general wireless local area networks.

A professional will usually do the installation and configuration of the various units, including programming the control units with the localization of the various sensors, e.g. that sensor number 2 is a water sensor placed close to the dishwasher. An alarm from this sensor could then trigger a valve that closes the water mains and sends a message to the proprietor, rather than contacting the fire brigade.

Thus installation cost is a main contributor to the total cost of a system.

US2008095441A1 discloses a system that uses bar codes for providing a service, where the bar code that identifies the selected service is tagged to a device before point of sale. However no configuration of the service or the device is made.

U.S. Pat. No. 7,378,942 teaches a method for integrating the tasks related to provisioning of a large alarm system, using a single database. This invention does not involve the point of sale applicable for smaller systems for use in homes or small offices. It is also most suitable for large, wired systems. U.S. Pat. No. 7,250,859 discloses a system where the configuration of the alarm system is automatically uploaded to a central station automation system. In the present invention the system is preconfigured at the point of sale and that information is downloaded to a central system.

U.S. Pat. No. 6,891,838 discloses a system and a method for monitoring reporting and controlling a residential system via a WAN, gateway, RF-transceivers, repeaters and software. US20070100585A1 discloses a system with a number of sensors and alarming using an SNMP module and a CRM system.

### SUMMARY OF THE INVENTION

In the present invention the system is preconfigured at the point of sale and this configuration information is downloaded to a central system.

A first aspect of the invention is a point of sale device for configuration of house automation. The point of sale device comprises: a reader arranged to read an identity associated with a sensor for home automation; an interface arranged to receive input of installation data of the sensor; and a communication module arranged to send the installation data and associated identity of the sensor to a server.

The term “sensor” is here used in a broad sense for a device that sends or receives signals as part of reporting events or acting on them. Examples are:
a smoke detector,
a water detector combined with an actuator that can close a valve and
a control for regulating temperature.

The reader may be configured to read an identity of a control unit.

The system may be arranged to encrypt communication between the wireless bridge and the server.

The system may further comprise a machine-to-machine gateway serving as a gateway between a plurality of wireless bridges and one server.

A third aspect of the invention is a method for house automation configuration. The method comprises the steps of: reading an identity associated with a sensor for home automation; receiving input of installation data of the sensor; and sending the installation data and associated identity of the sensor to a server.

A fourth aspect of the invention is a computer program loadable into the internal memory of a processing unit in a computer based system, comprising software code portions for performing the steps of the third aspect.

A fifth aspect of the invention is a computer program product stored on a computer readable medium, comprising a readable program for causing a processing unit in a computer based system, to control an execution according to the steps of the third aspect.

It is to be noted that, when appropriate, any feature of the first, second, third, fourth or fifth aspect may be applied to other aspects.

The present invention solves the problems of high installation cost, by pre-configuring the system at the point of sale, using barcodes or other methods of unique identification such as RFID on each unit. Such methods are called Automatic Identification and Data Capture (AIDC) and also include shape recognition, magnetic stripes and Optical Character Recognition (OCR). Each unit can then be identified at the point of sale, and its location in the building can be input to a computer. For example, the customer scans a first smoke detector and allocates it to the kitchen, the next smoke detector is scanned and allocated to the living room, then a first water detector is scanned and allocated to the kitchen, the next to the bathroom and so forth. The computer system may have drawings and floor plans of the customer's premises stored; either from public databases, input from the customer or from e.g. the builder. In one embodiment, the point of sale could mean at a time of distribution, at another place than in a shop, e.g. when processing large orders to housing cooperatives.

As the configuration information thus is known to a computer serving the point of sale, this computer may now communicate with a control unit already in place in the customer's building, or await that such a unit is installed, and then communicate the configuration data to this unit.

The control unit may use various forms of communication to the customer, e.g. report incidents and status information by SMS (short message service) or e-mail, or on a dedicated “my page” on the web. Instructions from the user, e.g. to turn on alarm sensors or to regulate heating or cooling, may be performed in a similar way.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a preferred implementation of the present invention,

FIG. 2 is a sequence diagram of the sales process in a preferred implementation of the present invention, and

FIG. 3 is a sequence diagram of the installation process in a preferred implementation of the present invention.

### DETAILED DESCRIPTION OF THE INVENTION

The present invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

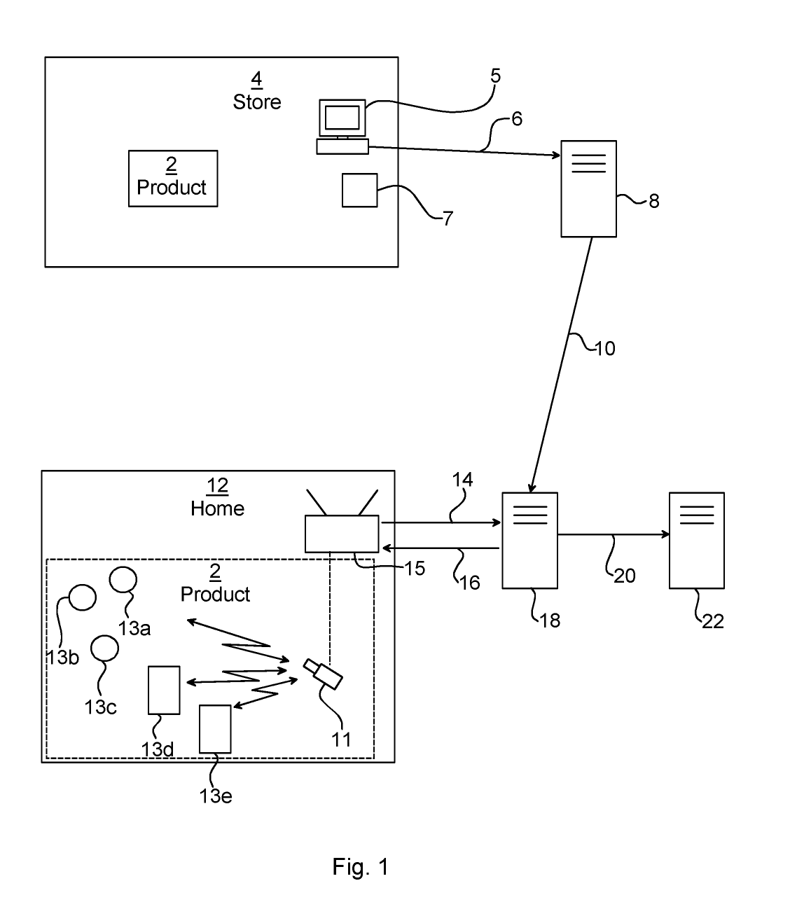

In an embodiment shown in FIG. 1, a wireless bridge 11 at the customer's premises 12 is implemented as a USB dongle plugged into a broadband home gateway 15. This dongle 11 may be bought together with sensors 13a-e and may be scanned together with the other parts of the system. The communication between the USB dongle and the various sensors 13a-e does not use a regular wireless LAN service of this unit 15, but rather a proprietary RF system in the 868 MHz band (or outside Europe the legal frequencies in the 900 MHz ISM band). The sensors 13a-e typically send an alive signal every 20-40 minutes at random intervals in addition to reporting relevant events. Some units, e.g. an automatic valve, may also listen continuously for instruction signals over the same, or a different interface.

Various technologies, such as Bluetooth or Wi-Fi, can be used as communication means between the sensors 13a-e and the home gateway 15. The choice of communication means and frequency bands depends on national regulations and the frequencies and range needed. In addition there are a number of industry standards that can be used, for example Z-Wave or ZigBee.

Sensors could also be connected to the wireless bridge using wired communication, for example ordinary LAN or communication over the mains. The wireless bridge could use such communication means available from the broadband home gateway 15.

In the embodiment in FIG. 1, the customer buys one or more new sensors in a product 2 in a store 4 and subsequently installs the sensors himself, without professional help. The product 2 includes one or more sensors and optionally a wireless bridge. The salesperson in the local store 4 has a graphical user interface of a computer 5 for registration of sensors. Using a reader 7 (e.g. bar code reader or other methods of unique identification such as RFID, shape recognition, magnetic stripes and/or Optical Character Recognition (OCR)), the product is scanned and to obtain identity information of the product 2, such as MAC address for the USB dongle and the hardware (HW) identity for each of the sensors 13a-e. The HW id can be implemented in firmware, but could also be stored in software or e.g. hardcoded in an RFID chip, similar to, but with longer range than, the Hitachi μ-Chip that can wirelessly transmit a 128-bit unique ID number which is hard-coded into the chip as part of the manufacturing process. The term HW id is used for the unique id of the unit, and does not imply that it has to be implemented in hardware. Additionally, the sales person enters, using a user interface of the computer 5, data about installation of the sensors, such as location, purpose of the sensors, etc.

This sensor data is sent to a server 8 for installation data. This server can for example be part of a service provider's Customer Relation System (CRM), e.g. provided by Siebel. A subset of the information is sent 14 to a gateway 18 called m2mGateway (machine-to-machine gateway) that serves a building with several flats and further 20 to a server 22 called “Interview”, the House Automation and Alarm Control Centre.

When the customer installs the alarm product, e.g. a new sensor, and connects the USB dongle 11 to the broadband home gateway 15, the USB dongle will communicate with the m2mGateway 18. The communication 14, 16 between the USB dongle and the m2mGateway can be encrypted in order to have sufficient level of security at the internet connection. When the m2mGateway identifies the USB dongle by its MAC address the HW identities for all the sensors 13a-e the customer has bought are retrieved 10 from the installation data server 8 and returned in order for the USB dongle 11 to know which sensors it shall accept. The House Automation and Alarm system is now installed and ready for use. The customer can be informed of the status of the installation e.g. by SMS, e-mail or a LED indicator at the dongle.

The m2mGateway 18 is not required in a system, but is advantageous from a data communication point of view, as it may be configured to aggregate alarm and system information—e.g. if a fire is reported in several flats—this unit 18 may aggregate the individual alarm messages to a single message, thus saving capacity and giving overview in the case of a large event.

The messages can be sent over one or more connections, such as using Internet and/or GSM, if the dongle or the gateway has a GSM module. A back-up battery may be used to provide power in case of power outage or sabotage.

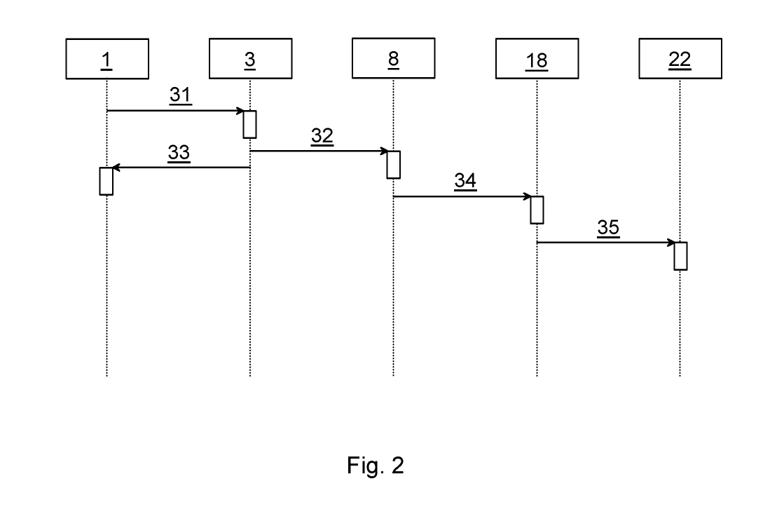

FIG. 2 shows the sale process sequence.
31. A customer buys a product comprising a USB dongle, and one or more sensors, such as smoke detectors and water detectors.
32. The salesperson registers customer details and the system equipment. In this embodiment, the boxes for the system equipment have bar codes with a MAC address and HW identities. The data, including the now defined sensor locations, i.e. the customer's premises and when possible where in the customer's premises, such as by the dishwasher, is stored in installation data server 8.
33. The customer can go back home and start the physical installation of the system, placing each sensor at its now defined location.
34. The customer information and the USB dongle MAC address and sensor HW identities are sent to the m2mGateway.
35. The m2mGateway will automatically transfer customer information to the Interview server 22 (House Automation and Alarm Control Centre).

The system is now ready for installation of the registered product.

In an alternative embodiment the sale process also include a large customer with multiple sites, e.g. a housing cooperative. The system configuration in this embodiment is done jointly with distributing the system to all tenants. I.e. the point of sale is distributed and also includes delivery of the system to the end customer. When the order arrives to a warehouse, the units for each apartment are picked from the warehouse shelves, scanned using the present invention and put in a box marked with the apartment number.

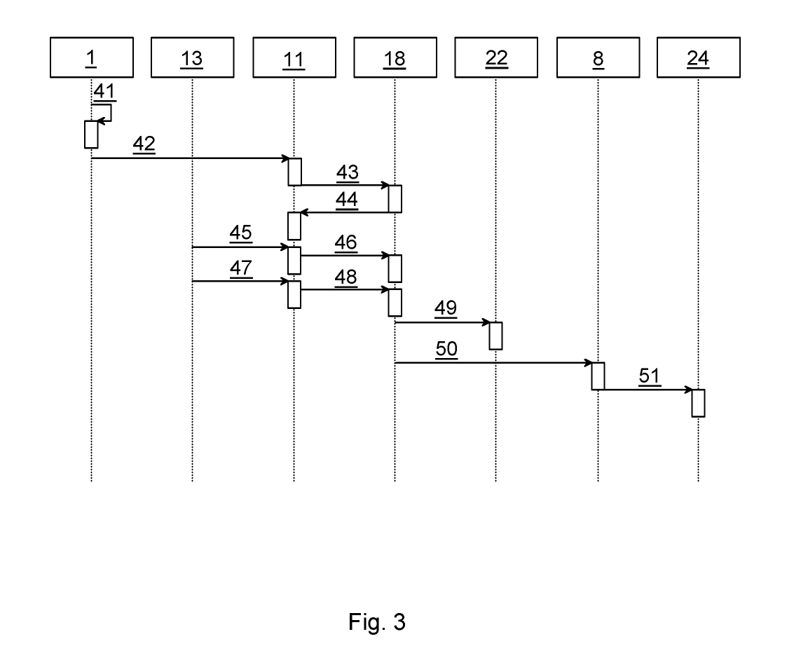

FIG. 3 shows the Installation Process Sequence.
41. A customer/installer 1 installs all sensors according to an installation instruction.
42. The customer/installer connects the USB dongle in the broadband home gateway.
43. The USB dongle sends its MAC address to the m2mGateway.
44. The m2mGateway returns a list of HW identities for the sensors to be supported by the system installation.
45. The sensors connect to the USB dongle (periodic supervision signal or similar).
46. The USB dongle reports to the m2mGateway that sensor is connected.
47. Step 45 is repeated for each sensor.
48. Step 46 is repeated for each sensor.
49. When all sensors are reported to be connected, Interview is informed that the concerned system installation is up and running.
50. When all sensors are reported to be connected, Siebel is informed that the concerned system installation is up and running.
51. Billing of the customer can be activated.

In an alternative embodiment, the wireless bridge is a control panel or control centre dedicated for home or office automation, with or without display and keypad. It is connected via an Ethernet connection to the broadband home gateway, or to an ordinary LAN router, rather than being a USB dongle. In this embodiment a NAT (Network Address Translation) translation functionality is used in order to support 2-way communication. 2-way communication at any time is required for control of devices (e.g. switch on/off power outlets) and for configuration of the system installation. In addition to simple NAT, there can also be a conversion between the various protocols used for automation and sensor communication. As for the dongle implementation, the communication with the optional m2mGateway can be encrypted.

In another alternative embodiment, the wireless bridge is embedded in a broadband home gateway. In this embodiment the control units' functionalities as described, are integrated in the gateway or added as a hardware plug-in, for example using USB. In an alternative embodiment, the point of sale scanner 7 recognizes bar codes and can additionally read serial numbers using OCR. A serial number, e.g. from the production of the unit, is printed on or placed on each unit and read using OCR. In another embodiment the bar code is used to determine the price and type of unit (e.g. USB dongle, fire sensor) and this information is used for the shop inventory and accounting purposes, whereas the identification for the purpose of the present invention is done in a separate scan, using bar code, RFID or OCR to identify the unit being registered. If the present invention is installed later or separate from the other point of sale systems, such as cash registers, it can be difficult to integrate the systems, and two separate scans, or a scanner that connects to both systems, can be used.

In another embodiment active RFID is used for one or more units. Active RFID communication is also used between the control unit, e.g. in a USB dongle, and sensors and actuators with active RFID. RFID tags can both store and transmit data. At the point of sale the unique identification of the unit is not read, but written into its RFID chip. That is, a unique ID suited for the present invention can be added. For example can the system use an ID that includes building, flat and room identity (like Building54Flat23KitchenSmokedetector1). The RFID may also contain other information for the system, e.g. expected duration of batteries, regular maintenance that is needed, location. In addition the chip may be programmed to communicate with the control unit. The standard ISO/IEC 18000: Information technology—Radio frequency identification for item management describes various implementations possibilities, including the use of the 860-960 MHz band for radio communication, together with other relevant frequencies such as 433 MHz and 2.45 GHz.

### The System, Software and Method

The point of sale device of the present invention consists of one or more computers implementing the system as described in independent claim 1 and the thereto belonging dependent claims.

The method of the present invention consists of the steps as described in independent claim 16 and the there to belonging dependent claims.

The software in the various units in the system of the present invention implements the steps as described in claims 17 and 18.

Here now follows a series of numbered clauses describing various embodiments.
I. System for house automation configuration, consisting of a customer relation system (CRM) server, and a set of one or more entities from the group; a machine-to-machine gateway (m2gateway), a broadband home gateway and a House Automation Control and Alarm Centre characterized by that said system consists of:
   at least one sensor,
   at least one control unit,
   at least one identification tag,
   a tag identifier at point of sale.
II. System for house automation configuration according to clause I, characterized by that said at least one sensor is in the form of an alarm transmitter.
III. System for house automation configuration according to clause I, characterized by that said at least one sensor has a hardware ID.
IV. System for house automation configuration according to clause I, characterized by that said at least one control unit is in the form of a USB dongle or a control panel.

V. System for house automation configuration according to clause I, characterized by that the control unit is connected to the broadband home gateway.
VI. System for house automation configuration according to clause I, characterized by that said control unit has a media access control (MAC) address.
VII. System for house automation configuration as described in clause I, characterized by that said control unit communicates with the sensors in the 433 or 868 MHz band.
VIII. System for house automation configuration as described in clause I, characterized by that the communication between the control unit and the House Automation Control and Alarm Centre is encrypted.
IX. System for house automation configuration described in clause I, characterized by that the m2mgateway communicates with at least one control unit.
X. System for house automation configuration as described in clause I, characterized by that said at least one sensor is connected to an identification tag.
XI. System for house automation configuration as described in clause I, characterized by that said at least one control unit is connected to an identification tag.
XII. System for house automation configuration as described in clause X and XI, characterized by that said identification tag is unique for every unit.
XIII System for house automation configuration as described in clause I, characterized by that said identification tag can be in the form of a BAR-code, RFID or Optical Character Recognition.
XIV. System for house automation configuration as described in clause I, characterized by that said identification tag is read.
XV. System for house automation configuration as described in clause I, characterized by that said identification tag is written.
XVI. Method for house automation configuration which include at least one identification tag, an identification tag reader, customer relation system (CRM) server, a set of one or more entities from the group; a machine-to-machine gateway (m2mgateway), a broadband home gateway and a House Automation Control and Alarm Centre characterized by that:
   at least one sensor is connected to an identification tag,
   at least one control device is connected to an identification tag,
   the CRM registers the control unit's media access control (MAC) address,
   the sensors' hardware (HW) identities and the customer registration information at point of sale,
   the CRM sends the information to the machine-to-machine gateway (m2mgateway) or broadband home gateway,
   the gateway sends the sensors' HW identities to the control unit and the customer registration to the House Automation Control and Alarm Centre after establishing a connection with the control unit.
XVII. Method for house automation configuration according to clause XVI characterized by that said identification tag is unique for every unit.
XVIII. Method for house automation configuration according to clause XVI characterized by that the control unit is connected to or embedded in the broadband home gateway.
XIX. Method for house automation configuration according to clause XVI characterized by that said m2mgateway can communicate with several control units.
XX. Method for house automation configuration according to clause XVI characterized by that said m2gateway upon receiving alarm or system messages from several control units sends one or more aggregated messages to the House Automation Control and Alarm Centre.
XXI. Method for house automation configuration according to clause XVI characterized by that said identification tag is read.
XXII. Method for house automation configuration according to clause XVI characterized by that said identification tag is written.
XXIII Computer program loadable into the internal memory of a processing unit in a computer based system, comprising software code portions for performing one or more steps of any clause XVI-XXII.
XXIV. Computer program product stored on a computer readable medium, comprising a readable program for causing a processing unit in a computer based system, to control an execution of one or more steps of any clause XVI-XXII.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A registration device for registering a sensor at a point of sale location prior to installation, the registration device comprising:
a reader configured to read, at the point of sale location, an identity associated with the sensor for installation in a home automation system;
an interface in communication with the reader, the interface configured to receive, read and input installation data of the sensor, the installation data including a second location different than the point of sale location, the second location being an installation location where the sensor will be installed, the installation data being readable from the point of sale location for configuring the sensor in its second location; and
a communication module in communication with the reader, the communication module configured to send the installation data and the identity of the sensor to a server for retrieval.

2. The registration device of claim 1, wherein the installation data includes data about a purpose of the sensor.

3. The registration device of claim 1, wherein the reader is arranged to read the identity using at least one of bar code reading, radio frequency identification (RFID) and optical character recognition.

4. The registration device of claim 1, further comprising a writer arranged to write data on a tag associated with the sensor.

5. A system comprising a registration device for registering a sensor at a point of sale location prior to installation, the registration device comprising:
a reader configured to read, at the point of sale location, an identity associated with the sensor for installation in a home automation system;
an interface in communication with the reader, the interface configured to receive, read and input installation data of the sensor, the installation data including a second location different than the point of sale location, the second location being an installation location where the sensor will be installed, the installation data being readable from the point of sale location for configuring the sensor in its second location; and
a communication module configured to send the installation data and the identity of the sensor to a server for retrieval.

6. The system of claim 5, further comprising a wireless bridge configured to communicate with the sensor.

7. The system of claim 6, wherein the sensor is one of an alarm transmitter, a smoke detector and a water detector and wherein the wireless bridge is further configured to:
receive an alive signal from the sensor at random intervals;
receive a report of an event from the sensor; and
send instructions to the sensor.

8. The system of claim 6, wherein the wireless bridge is in communication with a broadband home gateway that includes data on a plurality of sensors installed at a customer site, the plurality of sensors including the sensor.

9. The system of claim 8, wherein the wireless bridge is configured to receive from the broadband home gateway the identity associated with the sensor.

10. The system of claim 6, wherein the wireless bridge is a Universal Serial Bus dongle configured to report status information via at least one of Short Message Service (“SMS”), email and by sending the status information to a website, the website being configured to receive an input that at least one of turns on, turns off and regulates the sensor, the status information including an incident associated with the sensor.

11. The system of claim 6, wherein the wireless bridge has a media access control (MAC) address.

12. The system of claim 6, wherein the wireless bridge is in communication with the sensor using one of a frequency band of approximately 900 MHz, the ISM band, a frequency band of approximately 2450 MHz, the IEEE 802.11 Wi-Fi, ZigBee and Bluetooth band, and a frequency band of approximately 5800 MHz, the HIPERLAN and IEEE 802.11 Wi-Fi band.

13. The system of claim 6, wherein the wireless bridge is configured to communicate with the server, and wherein the communication between the wireless bridge and the server is encrypted.

14. The system of claim 6, further comprising a machine-to-machine gateway serving as a gateway between the wireless bridge and the server, the machine-to-machine gateway configured to:
identify the wireless bridge using a media access control (MAC) address;
retrieve the identity associated with the sensor from the server in communication with the registration device; and
transmit the identity associated with the sensor to the wireless bridge, the wireless bridge being further configured to receive the identity associated with the sensor, and determine, based at least in part on the identity, whether to accept communications from the sensor.

15. A method comprising:
reading at a point of sale location, using a reader, an identity associated with a sensor for installation in a home automation system;
receive, using an interface in communication with the reader, installation data of the sensor, the installation data including a second location different than the point of sale location, the second location being an installation location where the sensor will be installed, the installation data being readable from the point of sale location for configuring the sensor in its second location; and
send, using a communication module in communication with the reader, the installation data and the identity of the sensor to a server for retrieval.

16. The method of claim 15, wherein the server includes a floor plan of the second location.
